(19) United States
(12) Patent Application Publication
(10) Pub. No.: US 2003/0064683 A1
(43) Pub. Date: Apr. 3, 2003

(54) On board testing unit for multi-beam satellite and method of testing a satellite

(76) Inventors: Keith W. Matthews, Cypress, CA (US); Raymond M. Nuber, Rancho Palos Verdes, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 09/967,811

(22) Filed: Sep. 28, 2001

(51) Int. Cl. H04B 17/00

(52) U.S. Cl. 455/67.1; 455/429

(57) ABSTRACT

A multi-beam satellite (10) is provided including a first antenna (200) to receive a first plurality of beams, a second antenna (300) to transmit a second plurality of beams and an equipment compartment (100) coupled between the first antenna and the second antenna. The equipment compartment may include a testing unit (120) to test the first plurality of beams received at the first antenna and to stimulate signals to be transmitted by the second antenna as the second plurality of beams.

### BACKGROUND OF THE INVENTION

1. Field of the Invention

This invention generally relates to a multi-beam satellite and more particularly relates to testing a multi-beam satellite.

2. Description of the Related Art

Once launched, satellites need to be tested to ensure they perform as expected. This may involve a testing phase in which a satellite manufacturer needs to prove that the satellite functions and performs as originally required by the satellite's design specifications. Once a satellite is proven to function and perform properly, then it may be declared operational. This testing phase is often called an in-orbit test (IOT) and may include received G/T, transmit EIRP, bandwidth, and uplink and downlink C/I.

One method for testing a satellite is by transmitting a beam or signal up to the satellite and having the satellite relay that signal back down to a ground station or test station located on Earth. Parameters of the received signal may then be compared against parameters of the signal that was originally transmitted up to the satellite. Traditional satellites may only have a few beams and testing can be performed from one or a small number of ground station locations. However, when a satellite is capable of receiving and transmitting a large number of beams then logistical problems may occur during the testing phase. In such a circumstance, it may be extremely difficult and laborious to test each uplink beam and each downlink beam. It may be necessary for each beam to transmit a signal up to the satellite and have the signal relayed back down to Earth. This may entail an exceptionally large number of ground stations or test stations to be positioned at different locations around Earth. This type of testing is extremely laborious as it may involve a large number of ground stations for transmitting or receiving the beams. It is therefore desirable to provide a means for more efficiently testing multi-beam satellites.

### SUMMARY OF THE INVENTION

To achieve this and other objects, embodiments of the present invention may provide a multi-beam satellite that includes an on-board testing unit. More specifically, the multi-beam satellite may include a first antenna to receive a first plurality of beams, a second antenna to transmit a second plurality of beams and an equipment compartment coupled between the first antenna and the second antenna. The equipment compartment may include a testing unit to test the first plurality of beams received at the first antenna and to stimulate signals to be transmitted by the second antenna as the second plurality of beams.

The testing unit may separately measure parameters of each of the first plurality of signals transmitted from a ground station to the first antenna. The testing unit may also separately stimulate signals to be transmitted by the second antenna to the ground station.

The satellite may include a control system and a control communications system coupled to the control system. The control communications system may communicate with a test station to control operations of the satellite.

The testing unit may operate in conjunction with the control system to receive a first beam at the first antenna from a ground station, measure parameters of the first beam using the testing unit, reposition the satellite using the control system, receive a second beam at the first antenna from the ground station and measure parameters of the second beam using the testing unit.

The testing unit may also operate in conjunction with the control system to generate a first beam to be transmitted by the second antenna to a ground station, reposition the satellite using the control system and generate a second beam to be transmitted by the second antenna to the ground station (or other test location).

The testing unit may include a power meter to measure a signal strength of each of the beams received from Earth (or other test location). At least one test feed may be coupled to the first (receiving) antenna and to the testing unit so as to transmit a beam as one of the first and/or second plurality of beams to be received by the first antenna. A coupler may be provided in each transponder channel path so that the testing unit may inject any of the second plurality of signals into the second antenna.

Other objects, advantages and salient features of the invention will become apparent from the following detailed description taken in conjunction with the annexed drawings, which disclose preferred embodiments of the invention.

### BRIEF DESCRIPTION OF THE DRAWINGS

The invention will described in detail with reference to the following drawings in which like reference numerals represent like elements and wherein:

FIG. 1A is a block diagram of a satellite according to an example embodiment of the present invention;

FIG. 1B is a block diagram of a satellite showing downlink signal paths and a coupler according to an example embodiment of the present invention;

FIG. 2 is an example showing an uplink signal (beam) from a ground station to the satellite according to an example embodiment of the present invention;

FIG. 3 is an example of a downlink signal (beam) from the satellite to a ground station according to an example embodiment of the present invention;

FIG. 4 is a flowchart showing operations for testing the plurality of beams transmitted to the receive antenna according to an example embodiment of the present invention; and

FIG. 5 is a flowchart showing operations for testing the plurality of beams transmitted from the transmit antenna to a ground station according to an example embodiment of the present invention.

### DETAILED DESCRIPTION OF PREFERRED EMBODIMENTS

The present invention will now be described with respect to a multi-beam satellite that includes a first antenna to receive a plurality of beams (from Earth) and a second antenna to transmit a plurality of beams (to Earth). An equipment compartment may be coupled between the first antenna and the second antenna. The equipment compartment may include a testing unit to test the first plurality of beams (i.e., uplink beams) and to stimulate signals to be transmitted by the second antenna as the second plurality of beams (i.e., downlink beams). Embodiments of the present invention will hereafter be described. The terminologies of signal, signals, beam or beams may be used throughout and are meant to be interchangeable.

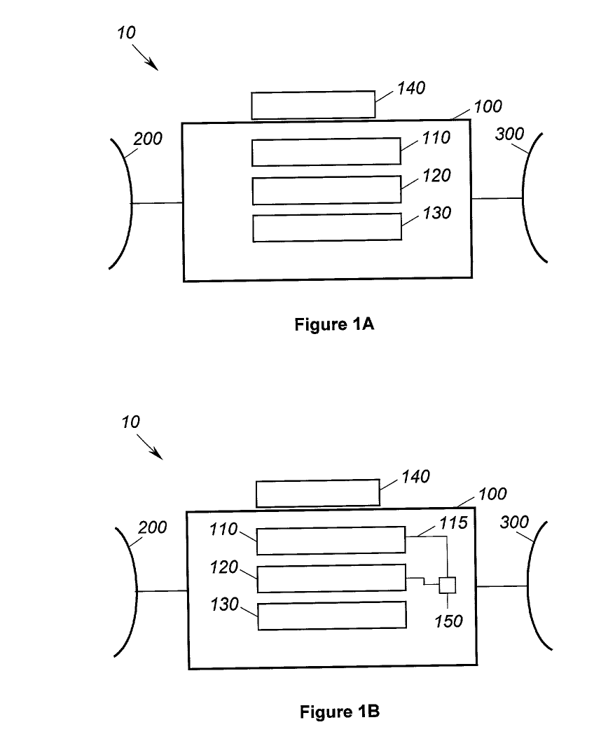

FIG. 1A is a block diagram of a satellite according to an example embodiment of the present invention. Other configurations and embodiments are also within the scope of the present invention. More specifically, FIG. 1A shows a satellite 10 having an equipment compartment 100, a receive antenna 200 and a transmit antenna 300. The receive antenna 200 is capable of receiving a plurality of separate uplink signals (or beams). Similarly, the transmit antenna 300 is capable of transmitting a plurality of separate downlink signals (or beams). The satellite 10 is considered a multi-beam satellite because of its ability to transmit and receive a plurality of beams.

The equipment compartment 100 may include a processor unit 110, a testing unit 120 and a communications control system 130. FIG. 1A merely shows these respective units within the equipment compartment 100 without any specific indication as to their connections. It is understood that these units may be coupled to each other, to the receive antenna 200 and to the transmit antenna 300 so as to perform the operations described below.

The communication control system 130 operates in conjunction with the control system 140 to communicate with a test station on Earth (or any test location) once the satellite 10 is in-orbit. The communications control system 130 and the control system 140 may perform many functions including, but not limited to, positioning the satellite 10 in the appropriate orbit, repositioning the satellite 10 once in-orbit, controlling the deployment of solar arrays, controlling the testing unit 120 and communicating between the testing unit 120 and a test station located on Earth (or any other test location).

As is well known, the control system 140 may include different types of mechanisms to position the satellite 10 in the orbit and repositioning the satellite 10 once in-orbit. This may specifically include an attitude control system (ACS) as is well known to one skilled in the art. The control system 140 may be considered as part of the equipment compartment 100 or it may be considered as an external part to the equipment compartment 100. The processor unit 110 may be involved in the overall operations of the satellite 10 as well as in controlling operations of the testing unit 120. The processor unit 110 may also operate in conjunction with a power amplifier and a filter to control (i.e., process) the uplink and downlink signals.

In accordance with embodiments of the present invention, the testing unit 120 may enable efficient in-orbit testing (IOT) capabilities from a minimal number of ground station locations and with a very little impact to the architecture of the equipment compartment. The testing unit 120 may operate to test the plurality of uplink beams that are received at the receive antenna 200 and to separately measure parameters of each of these signals. The testing unit 120 may also operate to stimulate signals to be transmitted by the transmit antenna 300 as separate downlink beams. FIG. 1B shows that these signals may be injected into downlink signal paths 115 by use of a coupler 150. Parameters of the beams transmitted from the transmit antenna 300 may be tested on Earth (or any other test location).

The testing unit 120 may include reuse of the telemetry circuits to measure the received G/T and uplink carrier to interference (C/I) ratio, for example. The testing unit 120 may also serve as a test signal generator for injecting test signals into the downlink beams (transmitted by the transmit antenna 300) for subsequent testing on Earth (or any other test location). Parameters of each of the beams received on Earth may be measured (or determined) in order to determine whether the satellite 10 operates and functions properly. In other words, the testing unit 120 may be capable of separately measuring each of the received beams and determining parameters of each of the received beams.

Data regarding the parameters may be separately communicated from the satellite 10 down to the test station or ground station using the communications control system 130. For example, the ground station or test station on Earth may communicate with the communications control system 130 using a command link and a TTC link. The command link may command the satellite 10 to perform certain functions such as engage in the in-orbit testing. On the other hand, the TTC link may enable the satellite 10 to communicate to Earth regarding the position of the satellite 10 as well as readings of the testing unit 120. These readings may include power meter readings and any other tests that may be performed by the testing unit 120. The testing unit 120 may also create signals to stimulate power amplifiers in the transmit antenna 300, the equipment compartment 100 or other component so as to generate the respective signals that are transmitted from the transmit antenna 300 down to the ground station or test station. For example, the testing unit 120 may separately generate the signals that are sent along each of the respective beams by the transmit antenna 300. These signals, for example, may be sent along each beam by coupling them into the downlink channel path(s) destined for the transmit antenna 300. Each signal (or beam) received on Earth from the transmit antenna 300 may have its parameters measured or determined using the appropriate testing equipment. The parameters that are received at Earth from either the communications control system 130 (i.e., the measurements of the testing unit 120) or the signals received from the transmit antenna 300 may then be compared against design specifications of the satellite 10 to determine if the satellite 10 operates and performs properly. The tests performed may include, but are not limited to the following: received G/T, transmit EIRP, bandwidth, and uplink and downlink C/I.

The satellite 10 may test each of the respective beams on the uplink side and each of the respective beams on the downlink side. In order to perform these functions more efficiently by utilizing less ground stations, the satellite 10 may reposition itself after each time a beam is tested on the uplink side and after each time a beam is tested on the downlink side. That is, the satellite 10 may be repositioned using its attitude control system (ACS) so that the beam under test is directed to a specific ground station. By repositioning the satellite 10 in this manner, a lesser number of ground stations may be used to perform the in-orbit tests on the multiple beams of the satellite 10.

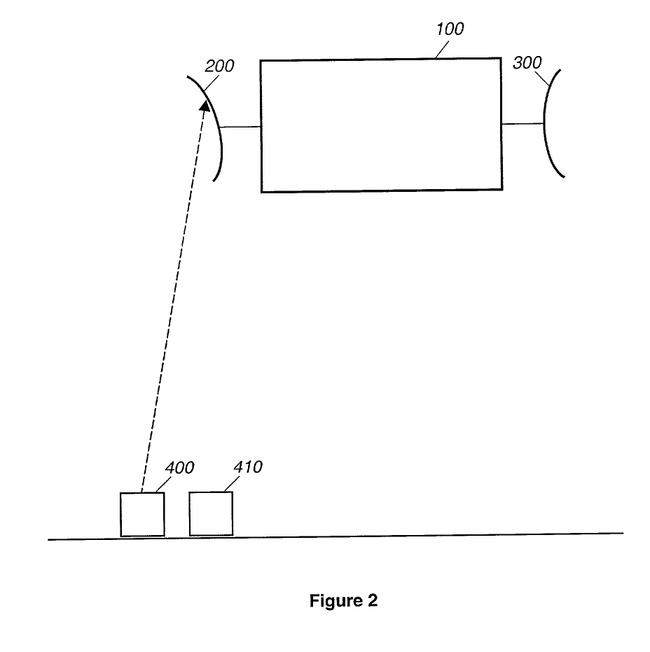

FIG. 2 shows a ground station 400 located on Earth and the satellite 10 provided in orbit. In this embodiment, the ground station 400 may transmit each of the respective plurality of beams from Earth to the satellite 10. In other embodiments, more than one ground station 400 may be used to transmit beams to the satellite 10. As discussed above, in order for each of the received beams to be properly tested, the satellite 10 may be repositioned using its control system 140. This repositioning is done so that the receive antenna 200 will receive each of the plurality of beams. Other embodiments are also within the scope of the present invention.

The ground station 400 may include a transmitter that is capable of transmitting testing signals (i.e., beams) to the satellite 10 which the satellite 10 is capable of identifying. In this example, the ground station 400 may transmit a very specific signal (s) to the satellite 10 for in-orbit testing. During testing, the ground station 400 may transmit a first signal (s) as the first beam to an exact position on the receive antenna 200. The satellite 10 may then appropriately determine parameters of this first beam received as the uplink signal 210. Data regarding the parameters of the first beam may then be stored within a memory onboard the satellite 10, may be transmitted to Earth using the communications control system 130 or may be transmitted to Earth using another viable means.

FIG. 2 shows a test station 410 located on Earth that communicates with the communications control system 130. The test station 410 is shown as a separate entity than the ground station 400 although the present invention is also applicable to the ground station 400 being part of the test station 410. After transmitting the first (test) beam to the satellite 10, the ground station 400 may then transmit a second signal (s) as the second beam to an exact position on the receive antenna 200. The satellite 10 may be repositioned prior to transmission of the second beam so that the second beam may be received at the receive antenna 200. Once again, parameters of the second beam may be measured (or determined) using the testing unit 120 located on the satellite 10. Data regarding these parameters may then be communicated back down to the test station 410 by the communications control system 130 (or other system) or may be stored on the satellite 10 for subsequent transmission to Earth.

The satellite 10 may then be repositioned so as to receive a third beam (signal) as the uplink signal 210 from the ground station 400. Parameters of the third beam may be measured (or determined) using the testing unit 120 in a similar manner as discussed above. Again, data regarding these parameters may be communicated to the test station 410 using the communications control system 130 (or other system) or may be stored in a memory device of the satellite 10 for subsequent transmission to Earth. These testing operations may continue until each of the respective uplink beams on the receive antenna 200 have been transmitted and tested at the satellite 10.

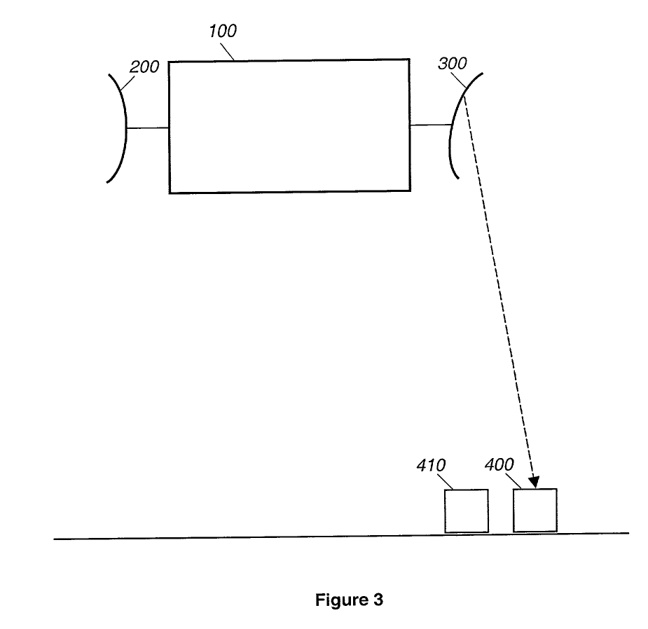

FIG. 3 shows a downlink signal 310 transmitted from the satellite 10 to the ground station 400. FIG. 3 also shows the test station 410 that is separate from the ground station 400 although the ground station 400 may be part of the test station 410 as indicated above. In this embodiment, the ground station 400 may include the necessary components (such as a receiver and testing equipment) to receive each of the beams transmitted by the transmit antenna 300. During testing, a first signal (or beam) may be transmitted as the downlink signal 310 from the transmit antenna 300 to the ground station 400. Parameters of the first signal (or beam) may then be measured (or determined) at the ground station 400 using the appropriate testing equipment such as power meters and other related testing equipment. These parameters may then be transmitted to the test station 410 (if not already received at the test station 410) or may be stored at the ground station 400 for later transmission to the test station 410. After testing of the first beam, the satellite 10 may be repositioned so as to transmit a second signal (or beam) as the downlink signal 310 to the ground station 400. In other words, a second beam may be transmitted from the transmit antenna 300 to the ground station 400. Parameters of the second beam may then be measured (or determined) and stored on the ground station 400 or transmitted to the test station 410 in a similar manner as discussed above. Subsequently, a third beam (or third signal) may be transmitted as the downlink signal 310 from the transmit antenna 300 to the ground station 400. Parameters of the third beam (or signal) may then be measured (or determined) and appropriately communicated to the test station 410 or stored in the ground station 400 for subsequent transmission to the test station 410. These operations may continue with the satellite 10 repositioning itself between each of the respective downlink beams that are transmitted from the transmit antenna 300 to the ground station 400.

The test station 410 may eventually receive test data regarding parameters for each of the uplink signals and each of the downlink signals. The test data regarding the parameters may then be compared against the design specification of the satellite 10 and the desired parameters that are required for the satellite 10 to be considered operating properly. Accordingly, based on the parameters received at the test station 410, a user may determine the status (e.g., fully operational or not fully operational) of the satellite 10.

Although the above embodiments describe one ground station 400, the present invention is not limited to those descriptions. That is, the present invention may also include embodiments in which more than one ground station may be simultaneously used to receive and/or transmit beams to/from the satellite 10.

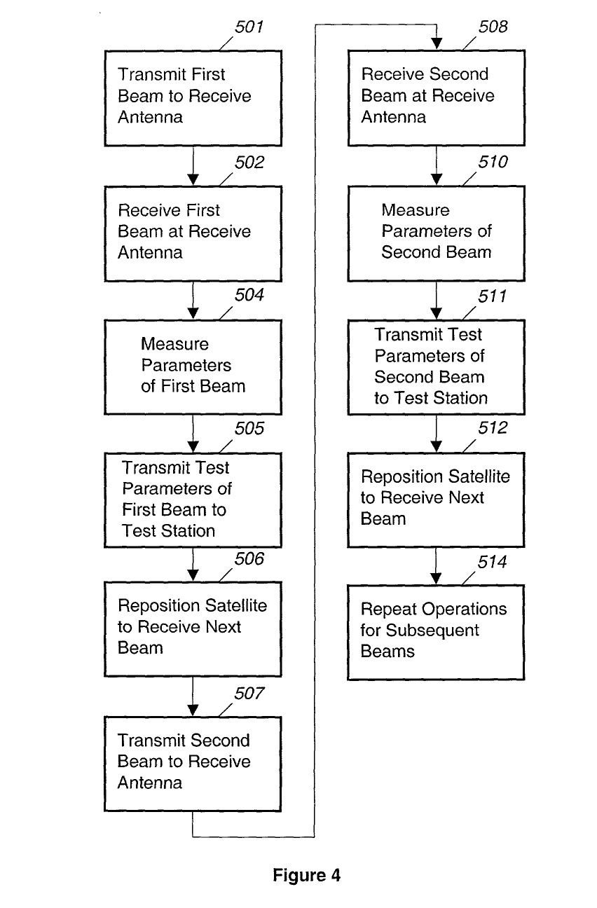

FIG. 4 is a flowchart showing operations for testing a plurality of uplink signals (or beams) that are to be received at the receive antenna 200. FIG. 4 merely shows one example embodiment of the present invention. Other embodiments and orders of operations are also within the scope of the present invention.

In block 501, a first beam may be transmitted from the ground station 400 to the receive antenna 200. The first beam may be received at the receive antenna 200 in block 502. Parameters of the first beam may then be measured in block 504. In this embodiment, the test data regarding the measured parameters of the first beam may be transmitted by the communications control system 130 to Earth in block 505. The satellite 10 may be repositioned in block 506 to prepare for a subsequent test beam. In block 507, a second beam may be transmitted from the ground station 400 to the receive antenna 200. The second beam may be received at the receive antenna 200 in block 508 and parameters of the second beam may be measured in block 510. The test data regarding the measured parameters of the second beam may be transmitted by the communications control system 130 to Earth in block 511. The satellite 10 may be repositioned in block 512 to prepare for a subsequent test beam. The operations of transmitting a beam, receiving the beam, measuring parameters of the beam, transmitting the measured parameters and repositioning the satellite 10 may be repeated for each of the remaining uplink beams in block 514. In this embodiment, the test data regarding the measured parameters for each of the uplink beams may be transmitted by the communications control system 130 to Earth subsequent to their measurement and prior to any repositioning of the satellite. Alternatively, the test data regarding the measured parameters may be transmitted to Earth for each uplink beam at any point after they are measured, including after all the uplink beams have been tested.

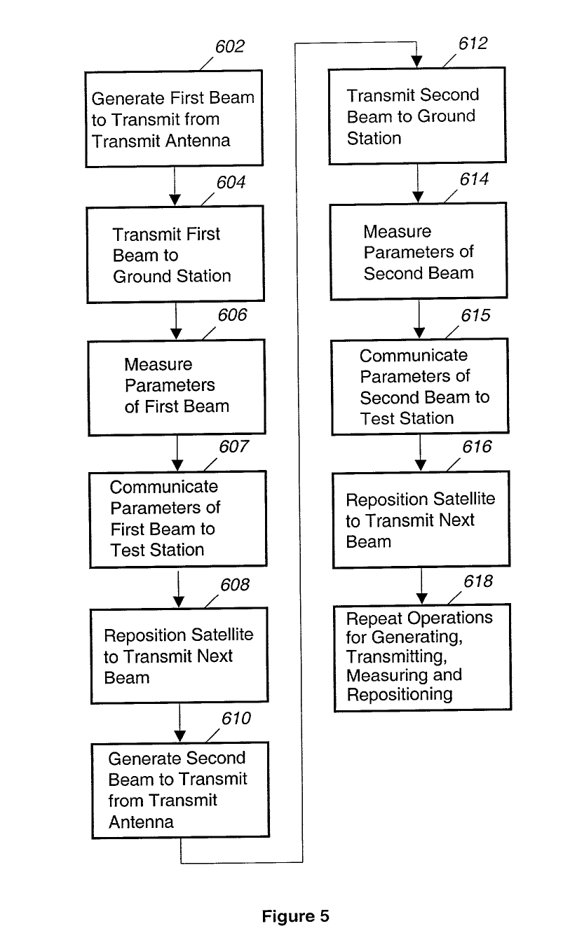

FIG. 5 is a flowchart showing operations for testing a plurality of downlink signals to be sent by the transmit antenna 300. FIG. 5 merely shows one example embodiment of the present invention. Other embodiments and orders of operation are also within the scope of the present invention.

In block 602, a first beam may be generated on the satellite 10 for transmission by the transmit antenna 300. The first beam may be transmitted by the transmit antenna 300 to the ground station 400 in block 604 and parameters of the first beam may be measured at the ground station 400 in block 606. In this embodiment, the test data regarding the measured parameters for the first beam may be communicated to the test station 410 in block 607. The satellite 10 may be repositioned in block 608 for testing of the next beam. In block 610, a second beam may be generated on the satellite 10 for transmission by the transmit antenna 300 to the ground station 400. The second beam may be transmitted by the transmit antenna 300 to the ground station 400 in block 612 and parameters of the second beam may be measured at the ground station 400 in block 614. The test data regarding the measured parameters for the second beam may be communicated to the test station 410 in block 615. The satellite 10 may be repositioned in block 616 for testing of the next beam. The operations of generating the beam, transmitting the beam, measuring parameters of the beam, communicating the test data regarding the measured parameters and repositioning the satellite 10 may be repeated for each of the subsequent beams in block 618. In this embodiment, test data regarding the measured parameters for each of the tested downlink beams may be communicated to the test station 410 subsequent to their measurement and prior to any repositioning of the satellite. Alternatively, the test data regarding the measured parameters for each downlink beam may be communicated from the ground station 400 to the test station 410 at any point after they are measured, including after all the downlink beams have been transmitted.

As discussed above, the testing unit 120 may operate to serve as a test signal generator for injecting test signals into downlink beams. In one embodiment, a test feed may be provided on each antenna to radiate a test signal into all of receive horns simultaneously. The testing unit 120 may have a transmit path straight to each of the test feeds. In another embodiment, a coupler may be provided in each transponder channel path so that the testing unit 120 may inject the signal into any given transponder channel that would in turn be transmitted down to the ground station 400. The test signals may be routed to each individual beam through the processing unit 110 for measurement on Earth. The test signal (or beam) may then be measured on Earth to determine the respective parameters such as EIRP, downlink C/I and bandwidth. The testing unit 120 may also be capable of sweeping a test signal across the transponder bandwidth and therefore would allow the bandwidth to be verified.

Embodiments of the present invention may provide a multi-beam satellite that may include a first antenna to receive a first plurality of beams, a second antenna to transmit a second plurality of beams and an equipment compartment coupled between the first antenna and the second antenna. The equipment compartment may include a testing unit to test the first plurality of beams received at the first antenna and to stimulate signals to be transmitted by the second antenna as the second plurality of beams.

Embodiments of the present invention may provide an easy solution to testing multi-beam satellites in an efficient and timely manner. This may reduce the in-orbit testing costs and allow a lower cost delivery in-orbit. This may also involve using a lesser number of test ground locations.

While the invention has been described with reference to specific embodiments, the description of the specific embodiments is illustrative only and is not to be construed as limiting the scope of the invention. Various other modifications and changes may occur to those skilled in the art without departing from the spirit and scope of the invention.

1. A multi-beam satellite comprising:
a first antenna to receive a first plurality of beams;
a second antenna to transmit a second plurality of beams; and
an equipment compartment coupled between said first antenna and said second antenna, said equipment compartment comprising a testing unit to test said first plurality of beams received at said first antenna.

2. The satellite of claim 1, wherein said testing unit separately measures parameters of each of said first plurality of signals received at said first antenna.

3. The satellite of claim 2, wherein said testing unit comprises a power meter to measure a signal strength of each of said first plurality of signals.

4. The satellite of claim 1, wherein said testing unit operates in conjunction with a control system to receive a first beam at said first antenna from a ground station, to measure parameters of said first beam using said testing unit, to reposition said satellite using said control system, to receive a second beam at said first antenna from said ground station and to measure parameters of said second beam using said testing unit.

5. The satellite of claim 1, wherein said testing unit further stimulates signals to be transmitted by said second antenna as said second plurality of beams.

6. The satellite of claim 5, wherein said testing unit separately generates signals to be transmitted by said second antenna to a test location.

7. A multi-beam satellite comprising:
a first antenna to receive a first plurality of beams;
a second antenna to transmit a second plurality of beams; and
an equipment compartment coupled between said first antenna and said second antenna, said equipment compartment comprising a testing unit to stimulate signals to be transmitted by said second antenna as said second plurality of beams.

8. The satellite of claim 7, wherein said testing unit separately generates signals to be transmitted by said second antenna to a test location.

9. The satellite of claim 7, wherein said equipment compartment further comprises at least one test feed coupled to said first antenna and to said testing unit so as to transmit a beam as at least one of said second plurality of beams.

10. The satellite of claim 7, wherein said equipment compartment further comprises a coupler provided in each downlink channel path so that said testing unit may inject any of said second plurality of signals into the second antenna.

11. The satellite of claim 7, wherein said testing unit operates in conjunction with a control system to generate a first beam to be transmitted by said second antenna to a ground station, to reposition said satellite using said control system, and to generate a second beam to be transmitted by said second antenna to said ground station.

12. The satellite of claim 7, wherein said testing unit tests said first plurality of beams received at said first antenna.

13. The satellite of claim 12, wherein said testing unit separately measures parameters of each of said first plurality of signals received at said first antenna.

14. A multi-beam satellite comprising:
a first antenna to receive a first plurality of beams;
a second antenna to transmit a second plurality of beams; and
an equipment compartment coupled between said first antenna and said second antenna, said equipment compartment comprising a testing unit to test said first plurality of beams received at said first antenna and to stimulate signals to be transmitted by said second antenna as said second plurality of beams.

15. The satellite of claim 14, wherein said testing unit separately measures parameters of each of said first plurality of signals received at said first antenna.

16. The satellite of claim 14, wherein said testing unit comprises a power meter to measure a signal strength of each of said first plurality of signals.

17. The satellite of claim 14, wherein said testing unit separately stimulates signals to be transmitted by said second antenna to a test location.

18. The satellite of claim 14, wherein said equipment compartment further comprises at least one test feed coupled to said first antenna and to said testing unit so as to transmit a beam as one of said second plurality of beams.

19. The satellite of claim 14, wherein said equipment compartment further comprises a coupler provided in each downlink channel path so that said testing unit may inject any of said second plurality of signals into the second antenna.

20. The satellite of claim 14, wherein said testing unit operates in conjunction with a control system to receive a first beam at said first antenna from a ground station, to measure parameters of said first beam using said testing unit, to reposition said satellite using said control system, to receive a second beam at said first antenna from said ground station and to measure parameters of said second beam using said testing unit.

21. The satellite of claim 14, wherein said testing unit operates in conjunction with a control system to generate a first beam to be transmitted by said second antenna to a ground station, to reposition said satellite using said control system, and to generate a second beam to be transmitted by said second antenna to said ground station.

22. A method of testing a multi-beam satellite having a first antenna and a second antenna, said method comprising:
receiving a first beam at said first antenna;
measuring a parameter of said first beam using a testing unit on said satellite;
repositioning said satellite;
receiving a second beam at said first antenna after repositioning said satellite; and
measuring a parameter of said second beam using said testing unit on said satellite.

23. The method of claim 22, further comprising communicating said parameter of said first beam and said parameter of said second beam to a test location.

24. A method of testing a multi-beam satellite having a first antenna and a second antenna, said method comprising:
transmitting a first beam from said second antenna to a test location;
repositioning said satellite; and
transmitting a second beam from said second antenna to said test location.

25. The method of claim 24, further comprising:
measuring a parameter of said first beam at said test location; and
measuring a parameter of said second beam at said test location.
